(19) United States
(12) Patent Application Publication
(10) Pub. No.: US 2008/0074866 A1
(43) Pub. Date: Mar. 27, 2008

(54) VISOR VANITY

(75) Inventors: Daniel R. Barker, Hudsonville, MI (US); William R. Beland, Grand Haven, MI (US); Gregory N. Brncick, Holland, MI (US); Philip Lehman, West Olive, MI (US); Paul C. Schutter, Kent City, MI (US); Steven M. Spoerre, Holland, MI (US)

Correspondence Address: FOLEY AND LARDNER LLP;SUITE 500, 3000 K STREET NW, WASHINGTON, DC, 20007, US

(73) Assignee: Johnson Controls Technology Company

(21) Appl. No.: 11/689,255

(22) Filed: Mar. 21, 2007

Related U.S. Application Data
(60) Provisional application No. 60/785,062, filed on Mar. 23, 2006.

(51) Int. Cl. F21V 33/00; G02B 7/182

(52) U.S. Cl. 362/142; 359/871

(57) ABSTRACT

A vanity for a visor having a cover attached to a frame at a pivot point is disclosed. An extension arm is connected to the cover and a metal pin extends from the extension arm. At least one metal stamping extends from the frame. When the cover is closed, the extension arm rotates the metal pin into contact with the metal stamping. When the cover is opened, the extension arm rotates the metal pin out of contact with the metal stamping. First and second actuation tabs may be connected to the cover and a pair of stamping legs extend from the frame. When the cover is closed, the first actuation tab prevents contact between the pair of stamping legs but permits contact between the pair of stamping legs when the cover is open. When the cover is opened, the second actuation tab causes contact between the pair of stamping legs.

### CROSS REFERENCE TO RELATED APPLICATIONS

The present application claims priority to and the benefit of U.S. Provisional Patent Application Ser. No. 60/785,062, filed Mar. 23, 2006, which is hereby incorporated by reference herein in its entirety.

### BACKGROUND

The present invention relates generally to the field of vanities for visors used in vehicles and methods for making such vanities. More specifically, the present invention relates to a vanity providing a positive on/off feature for actuating the vanity light. The invention further relates to a vanity having a snap element to hold the vanity mirror in place. Additionally, the invention relates to a top-loaded vanity where all of the vanity components may be loaded from the top side, and a method for making such a visor.

Vanities used in vehicle visor assemblies to provide a mirror and/or lighting to an occupant are generally known. Typically, the visor vanity includes a mirror and one or more lights, the lights often being located on opposite sides of the mirror. The vanity may additionally include a cover assembly that covers the mirror, vanity light or lights, or both.

In assembling such a visor vanity, the mirror is often loaded from the back, along with the circuitry needed to power the vanity lighting. The edge portion of the mirror may be slid over one or more snap surfaces, thereby securing the mirror in place. This type of installation poses risks, in damage to the mirror or other components, and injury to the assembler. The circuitry is often installed in a backer (e.g., trapped in a cardboard backer or insert molded into a plastic backer) behind the mirror. The vanity is then turned over and the remaining components, such as the lighting, lens components, cover, etc., are loaded from the front.

During use, a visor is pivoted down from its stowed position, exposing the vanity assembly to an occupant of the vehicle. An on/off switch is typically provided, allowing a user to turn the vanity lighting on or off. Alternatively, the vanity lighting may be actuated upon the opening of the vanity cover through a cantilever type metal stamping closing an electrical circuit through contact with another metal stamping. Often, however, through loss of spring memory or corrosion, the metal stampings may stick together even when the vanity cover is closed, resulting in poor electrical contact and posing risks such as unnecessary battery power usage and potential fire hazards for vehicle occupants.

One challenge associated with traditional visor vanities is minimizing the number of components and steps involved in the assembly of a vanity mirror. Ideally, the number of components and steps involved in the assembly process should be minimized.

An additional challenge is providing a vanity that is safe and easy to assemble, and minimizes the risks of damage to the vanity components and injury to the assemblers.

An additional challenge is providing a vanity with a positive on/off feature for the vanity lighting circuitry that avoids “flickering” of the lights or poor contact between electrical connections due to the loss of spring memory or corrosion.

Accordingly, it would be desirable to provide a vanity that could be entirely assembled from only one side of the vanity, minimizing the number of components and assembly steps involved in the assembly process.

It would also be desirable to provide a vanity with a snap feature that provides a safe and secure way to mount the vanity mirror without the risk of damage to the vanity components or injury to the assemblers.

It would also be desirable to provide a vanity having a positive on/off feature for the vanity lighting that actuates the lighting upon the opening of the vanity cover assembly and provides a positive force to deactuate the vanity lighting.

Accordingly, it would be advantageous to provide a vanity and a method for making a vanity having one or more of these advantageous features.

### SUMMARY

The invention relates to a vanity for a visor having a cover attached to a frame at a pivot point. An extension arm is connected to the cover and a metal pin extends from the extension arm. At least one metal stamping extends from the frame. When the cover is closed, the extension arm rotates the metal pin into contact with the metal stamping. When the cover is opened, the extension arm rotates the metal pin out of contact with the metal stamping.

The invention further relates to a vanity for a visor having a cover attached to a frame at a pivot point. First and second actuation tabs are connected to the cover and a pair of stamping legs extend from the frame. When the cover is closed, the first actuation tab prevents contact between the pair of stamping legs but permits contact between the pair of stamping legs when the cover is open. When the cover is opened, the second actuation tab causes contact between the pair of stamping legs.

The invention further relates to a vanity for a visor having a frame and a mirror. The frame is configured to receive the mirror from a bottom surface. At least one upstanding leg is attached to the bottom surface of the frame. The leg is configured to be folded at a hinge portion so that a snap passes through an aperture in the leg and secures the leg in the folded position such that a portion of the leg is in contact with the mirror.

The invention further relates to a vanity for a visor having a frame, a mirror, a light assembly, and a cover. The vanity has a top surface that is viewable by an occupant of a vehicle when in use. The frame is configured such that all of the components may be assembled to or disassembled from the frame from the top surface side.

The invention further relates to a method for making a vanity for a visor. The method includes the steps of providing a vanity frame having a first side with a top surface, and installing a light assembly, a mirror assembly, and cover assembly from the first side of the vanity.

It is to be understood that both the foregoing general description and the following detailed description are exemplary and explanatory only, and are not restrictive of the invention as claimed.

### BRIEF DESCRIPTION OF THE DRAWINGS

The features, aspects, and advantages of the present invention will become apparent from the following description, appended claims, and the accompanying exemplary embodiments shown in the drawings, which are briefly described below.

FIG. 1 is a perspective view of a vanity according to an embodiment of the present invention with the cover open.

FIG. 2 is a perspective view of the vanity of FIG. 1 shown with the cover closed.

FIG. 3 is a schematic view of a portion of a vanity according to an embodiment of the present invention with the cover closed.

FIG. 4 is a schematic view of the portion of the vanity of FIG. 3 shown with the cover open.

FIG. 5 is a schematic view of a portion of a vanity according to another embodiment of the present invention with the cover closed.

FIG. 6 is a schematic view of the portion of the vanity of FIG. 5 shown with the cover open.

FIG. 7 is a schematic view of the portion of the vanity of FIG. 5.

FIG. 8 is a perspective view of a vanity according to another embodiment of the present invention.

FIG. 9 is a partial perspective view of the vanity of FIG. 8.

FIG. 10 is a partial perspective view of the vanity of FIG. 8 showing a profile of a leg in a folded position.

FIG. 11 is a partial perspective view of an alternative embodiment of FIG. 10 showing a profile of a leg in a folded position

FIG. 12 is an exploded perspective view of a vanity according to an embodiment of the present invention.

FIG. 13 is an alternative embodiment of FIG. 12 showing the vanity frame integrated with the visor core.

### DETAILED DESCRIPTION

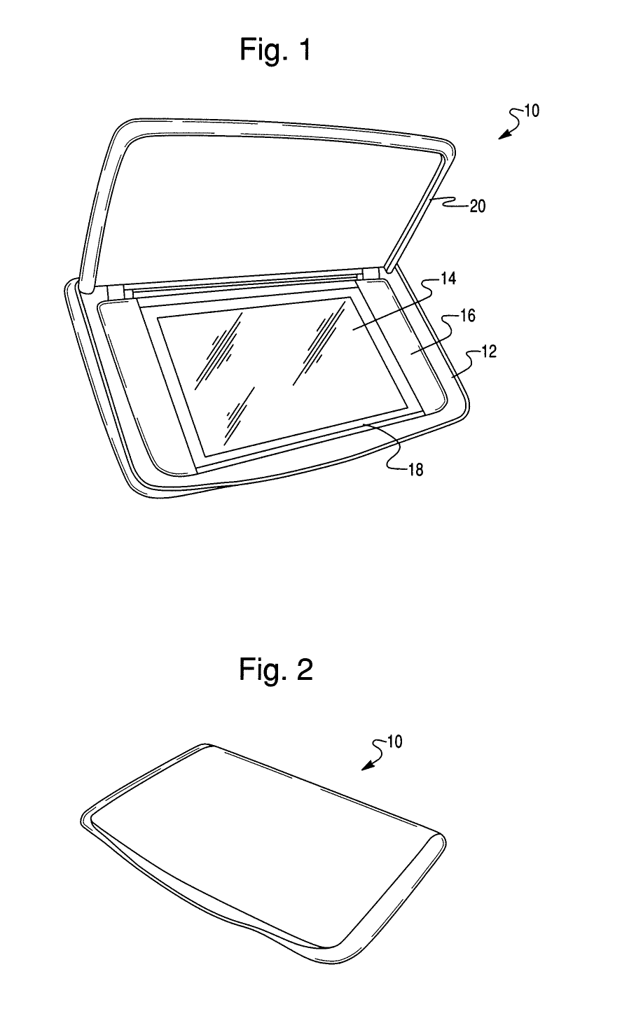

Referring to FIGS. 1 and 2, a vanity 10 used in a vehicle visor may include a frame or housing 12 which houses a mirror 14 and one or more vanity lights or fixtures (i.e., vanity lightning) that are stored behind lenses 16, which may be installed on opposing sides of the mirror 14. Alternatively, a single light may be located above the mirror. The mirror 14 is often held in place by a trim bezel 18 around the periphery of the mirror. The vanity 10 additionally includes a cover 20 that closes over one or both of the mirror 14 and lighting fixtures when the vanity is not in use. Additionally, the vanity 10 includes circuitry and switching components (not shown) required to power the vanity lighting. The vanity lighting may be turned on and off by various means, including an on/off switch manually operated by a passenger, or by components housed within the vanity 10 that provide for a closed circuit (i.e., “power on”) when the vanity cover 20 is opened, and an open circuit (i.e., “power off”) when the vanity cover 20 is closed.

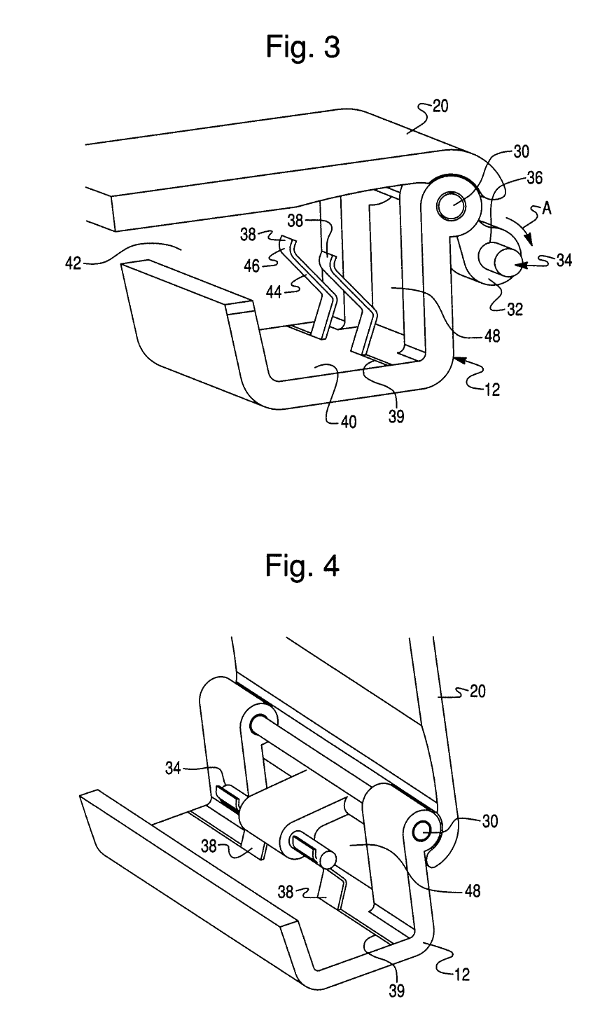

Referring to FIGS. 3 and 4, a portion of a vanity 10 according to an embodiment of the present invention is shown, which includes a portion of the cover 20 and a portion of the frame 12. The cover 20 and the frame 12 are pivotally coupled together along a pivot axis 30 using any conventional means (e.g., a pivot hinge or pin), thereby allowing the cover to pivot between a closed position as shown in FIG. 3 and an open position as shown in FIG. 4. The cover may also be configured to maintain one or more intermediate positions between the fully open or fully closed positions. The cover 20 and frame 12 may be made of any suitable material, such as a plastic, and may be injection molded or made through any other suitable manufacturing process.

As shown in FIG. 3, extending from the cover 20 is an extension arm 32 that receives a metal pin 34. The extension arm 32 may be formed as an integral part of the cover 20, or may be insert molded, ultrasonically welded, mechanically fastened, or secured to the cover using any other suitable means. The extension arm 32 has an aperture or hole 36, to allow a section of the metal pin 34 to be positioned within the hole 36. As partially shown in FIG. 3, the pin 34 extends through the hole and beyond both sides of the extension arm 32. The pin 34 may form a part of the lighting circuitry and is therefore made from a suitably conductive material. The pin 34 and hole 36 are shown as having a generally circular cross-section; however, any suitable form or cross-section may be used such that the pin fits within the hole 36 of the extension arm 32. The pin 34 may be adhesively secured to the extension arm 32, insert molded, press/interference fitted, mechanically fastened, or secured to the extension arm using any other suitable method. In an alternative embodiment (not shown), the pin 34 also acts as the extension arm 32 and is therefore secured directly to the vanity cover 20. In other words, the pin and extension arm are integrally formed, attached to the cover, and capable of being put into contact with the metal stampings, which are discussed below.

As shown in FIG. 3, extending from the frame 12 are a pair of metal stampings or stamping legs 38. Each stamping leg 38 extends upward from an inner surface 40 of the vanity frame 12. The stamping legs 38 are located in an interior portion 42 of the vanity 10 adjacent to the pivot axis 30. The stamping legs may be adhesively secured, insert molded, interference fitted, or otherwise secured to the frame 12 using any suitable means. The metal stamping legs 38 also form a part of the lighting circuitry, being electrically coupled to the lighting circuitry, and are therefore made of a suitably conductive material. As shown in FIG. 3, the stamping legs have a generally “S” shape, with a flat central portion 44 leading into an upper curved portion 46. The flat central portion 44 and the upper curved portion 46 provide a contact surface for the stamping legs 38 to engage with the pin 34, as shown in FIG. 4. In an alternative embodiment, the stamping legs 38 may be formed to be a substantially straight, concave, convex, or other suitable shape. The stamping legs 38 are located so that when the vanity 10 is fully assembled, the stamping legs are concealed behind the vanity frame 12, the lens components, or another vanity component so as not to be visible to the occupant of a vehicle.

The metal pin 34 and the metal stamping legs 38 are integrated into the vanity lighting circuitry and interact such that when the metal pin and the metal stamping legs 38 are in contact with each other, the lighting circuit is closed, and the vanity lighting is “on.” Conversely, when the metal pin 34 and the metal stamping legs 38 are not in contact with each other, the lighting circuit is open, and the lighting is “off.” Accordingly, whether the vanity lighting is on or off depends upon whether the metal pin 34 and the stamping legs 38 are contacting each other. For example, the stamping legs 38 are in electrical contact with conductors 39 of the lighting circuitry. Other circuitry components, such as a dimming feature to control the lighting intensity, may be additionally included in the lighting circuitry for the vanity.

Further referring to FIGS. 3 and 4, the extension arm 32 rotates with the vanity cover 20 about the pivot axis 30 when the vanity cover 20 is pivoted. The vanity frame 12 is provided with an aperture or opening 48, configured to allow the extension arm 32 and metal pin 34 to rotate toward the metal stamping legs 38 as the vanity cover 20 is opened. In an alternative embodiment (not shown), the extension arm 32 and the metal pin 34 may be entirely captured within the periphery of the vanity frame or housing 12 in both the open and closed positions, eliminating the need for the aperture 48 in the frame. The extension arm 32 and metal pin 34 are configured such that upon opening the vanity cover 20, the metal pin 34 is rotated in the direction of arrow A in FIG. 3 into contact with the pair of metal stamping legs 38 secured to the vanity frame 12 (see FIG. 4). Upon engagement of the pin 34 with the stamping legs 38, the lighting circuit is closed and the vanity lighting turns on. The metal stamping legs 38, extension arm 32, and metal pin 34 may be additionally configured such that when the metal pin 34 contacts the metal stamping legs, the pin causes the stamping legs to deflect, thus creating a bias force between the metal pin and the metal stamping legs. This bias is intended to ensure a good electrical connection between the pin and the stamping legs for the lighting circuitry when the vanity cover 20 is open and the lighting in on.

When the cover 20 is closed, the force of closing the cover provides a positive force that causes the extension arm 32 and therefore the metal pin 34 to pivot out of contact with the metal stamping legs 38, thereby opening the lighting circuit and turning the vanity lighting off, such as the position seen in FIG. 3. The positive force provided to move the pin 34 away from the metal stamping legs 38 and therefore open the lighting circuit is intended to be an advance over many traditional vanity systems, which often rely much more upon spring forces and are much more susceptible to the circuit remaining closed due to corrosion, sticking, spring relaxation, etc., even when the cover 20 is closed.

The embodiments disclosed in FIGS. 3 and 4 show a single metal pin 34 extending from both sides of the extension arm 32 and configured to contact a pair of metal stamping legs 38. In an alternative embodiment (not shown), the pin 34 may extend from only one side of the extension arm 32 to make contact with two stamping legs. In another alternative embodiment, more than one pin may be used along the length of the pivot axis 30, which engage one or more metal stamping legs at a discrete number of contact positions. Various other embodiments utilizing the components described herein are also possible.

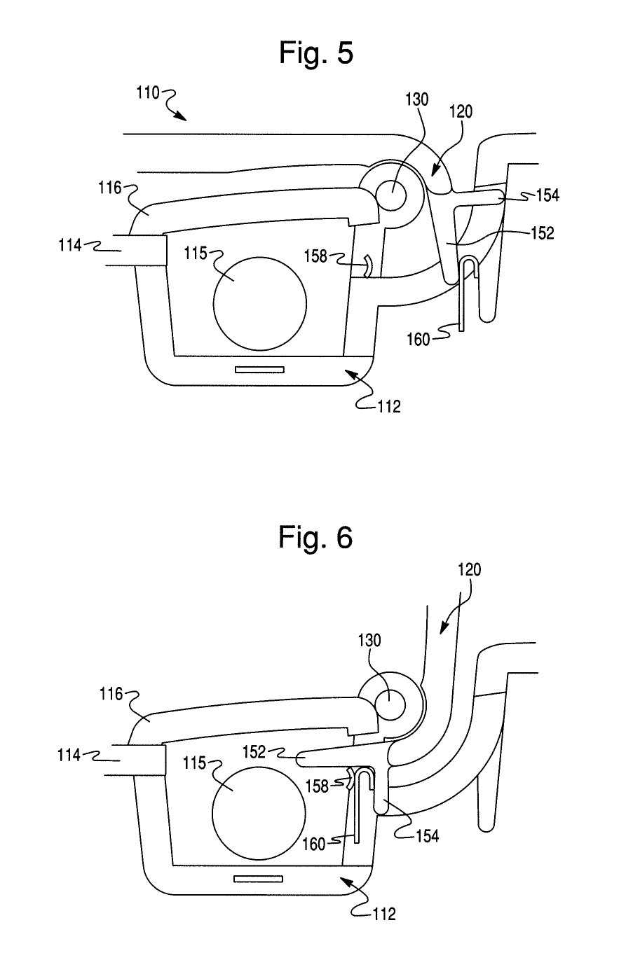

Referring to FIGS. 5-7, in an alternative embodiment, the vanity 110 includes a mirror 114, vanity lighting 115, and a lens 116, as well as a frame 112 (shown as a section of the frame) and a vanity cover 120 (shown as a section of the cover) pivotally connected along a pivot axis 130 (e.g., as defined by a hinge or pin). The cover 120 pivots from a closed position (as seen in FIG. 5) to an open position (as seen in FIG. 6), and may be positionable at one or more intermediate positions between the fully closed and fully open positions.

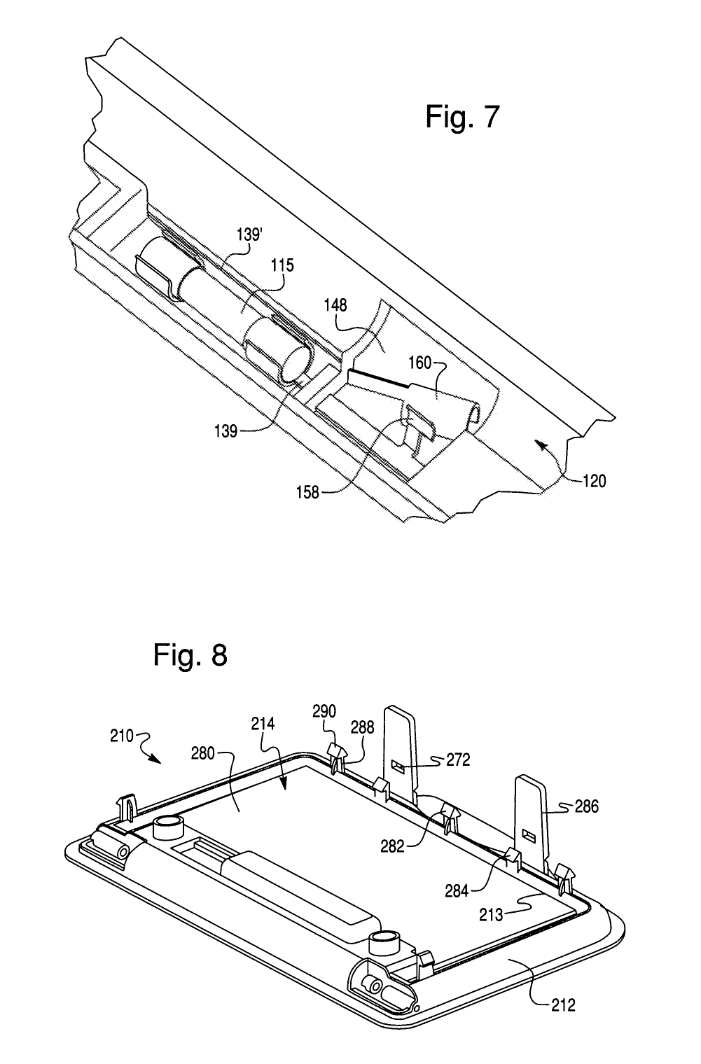

As shown in FIG. 5, the cover 120 has first and second actuation tabs 152 and 154 extending from the portion of the cover 120 proximate the pivot axis 130. The tabs 152 and 154 may be made of any suitable material (e.g., plastic) and may be integrally formed as a part of the cover 120, or may be separately formed pieces that are attached to the cover using any suitable means (e.g., insert molding, ultrasonic welding, adhesives, etc.). The tabs 152 and 154 are secured to the cover such that the tabs rotate with the cover. The tabs are configured to rotate though an aperture 148 in the vanity frame 112 (as seen in FIG. 7) as the cover 120 is rotated about the pivot axis 130. The tabs 152 and 154 are shown as being generally straight, with substantially flat surfaces, but may be any suitable shape and have various cross-sectional configurations, such as curved surfaces.

As further shown in FIGS. 5-7, the vanity 110 includes first and second stamping legs 158 and 160. The legs extend from an inner portion of the vanity housing or frame 112, and are located proximate the pivot axis 130. The legs 158 and 160 form a part of the vanity lighting circuitry, and are thus made from a suitably conductive material. The legs may be formed by a stamping operation, and may have a spring memory so as to allow the two legs to be placed into a biased engagement. Additionally, the legs may be stamped as integral parts of a larger portion of the vanity lighting circuitry. As shown in FIGS. 5 and 7, the first leg 158 has a crescent shape, or a reverse “C” shape at its distal end while its proximal end is in electrical contact with the conductor 139. The second leg 160 is substantially shaped similar to an upside-down “J” at its distal end while its proximal end is in electrical contact with the conductor 139′. In addition, the second leg 160 may be bent or protrude out of the aperture 148 located in the cover 120 and/or frame 112 so as to be in a spaced relation with the first leg 158. It should be noted that any suitable shapes for the legs may be chosen. The configurations shown include curved surfaces intended to allow for a sufficient bias force upon engagement of the legs.

The conductor 139 may be connected to the vanity lighting 115, such as a light bulb, LED, or the like, which is located behind the lens 116. The conductor 139′ may by connected to a power source, such as a battery.

The first and second legs 158 and 160 act as a switching mechanism for the vanity lighting. When the first and second stamping legs are in contact with each other, the lighting circuit is closed, and the lighting is on because the vanity lighting 115 is in electrical contact with the power source. Conversely, when the first and second legs are not in contact, the lighting circuit is open, and the vanity lighting is off because the vanity lighting 115 is not in electrical contact with the power source. Other components, such as a dimming feature to control the intensity of the vanity lighting, may additionally be included as a part of the vanity lighting circuitry. For example, the dimming control can be placed between the first leg and the lighting or between the second leg and the power source.

Referring to FIG. 5, when the vanity cover 120 is in the closed position, the first 152 tab is in contact with the second stamping leg 160 such that the first tab 152 maintains the second leg 160 at a predetermined distance from the first leg 158, keeping the lighting circuit open and the lighting off. Referring to FIG. 6, as the vanity cover is rotated to the open position, the first tab 152 disengages the second stamping leg 160 and rotates with the cover 120 past the first stamping leg 158. At the same time, the second tab 154 rotates into engagement with the second leg 160 and forces the second leg into contact with the first leg 158, thereby closing the lighting circuit and turning the lighting on. In a preferred embodiment, the first leg and the second leg are forced into engagement with each other such that a bias force exists at the interface between them. This bias is intended to ensure a good electrical connection between the stamping legs.

The positive force provided by the first and second tabs 158 and 160 on the second leg 160 to move it out of and into engagement with the first leg 158 is intended to be an advance over many traditional vanity assemblies that rely more heavily on the resiliency of the metals involved in the switching mechanism, and are therefore more susceptible to “sticking” of components due to corrosion and other factors.

Referring to FIGS. 8-10, another embodiment of the present invention is illustrated. It should be pointed out first that the vanity in FIGS. 1 and 2 has a top surface, which may include the vanity cover. FIGS. 8-10 also has these components but generally depict various components secured either to or via the bottom surface 280 (i.e., the surface not visible to an occupant of a vehicle) of the vanity 210. As shown in FIG. 8, the vanity 210 may include a frame or housing 212, a mirror 214, one or more connectors 282 used to mount the vanity 210 to a visor, one or more snaps 284, and one or more upstanding legs 286, each snap being associated with a leg.

The rear surface of the mirror 214 is shown in FIG. 8. The mirror 214 is held in place from the top by the vanity frame 212 or a trim bezel (such as the one shown in FIG. 1) that interfaces with at least a portion of the periphery of the front surface of the mirror 214. From the bottom, the mirror is secured in place with the snaps 284 and legs 286.

Further referring to FIG. 8, one or more connectors 282 are shown. The connectors have a lower portion 288 and an enlarged upper portion 290. The connectors 282 may be configured to be pressed through undersized apertures in a visor and hold the vanity 210 in place. The connectors 282 may be made of any suitable material (e.g., plastic), and may be integrally formed with the vanity frame 212, or may be separate pieces that are then secured to the vanity frame using any suitable means.

The frame 212 includes a plurality of snaps 284. The snaps are arranged such that they border at least a portion of the periphery of the mirror 214 once the mirror is installed, but are set back from the mirror edges 213 sufficiently such that the mirror 214 may be placed into the frame 212 without having to slide one or more portions of the mirror 14 over the snaps. This configuration is intended to avoid both damage to the mirror 214 and/or snaps 284, and injury to the assemblers. As shown in FIGS. 8-10, each snap has a lower portion 294 and an upper portion 296. The upper portion 296 is larger than the lower portion 294 such that a shoulder 298 exists on one side of the snap at the interface between the lower portion and the bottom surface of the upper portion. In an alternative embodiment, shoulders 298 may be provided on more than one side of each snap so as to be similar in shape to the connector 282. The top surface 270 of the upper portion 296 may be tapered so as to facilitate the passing of the upper portion 296 of the snap through an undersized aperture 272 in its corresponding leg 286. The snaps 284 may be made of plastic and integrally molded as a part of the vanity frame 212. In an alternative embodiment, the snaps 284 may be separately formed pieces that are then secured to the frame using any suitable fastening method, such as an interference fitting or adhesive.

Each snap 284 in FIGS. 8-10 is associated with an upstanding leg 286. The legs may be either an integral part of the frame 212 or be otherwise secured to the frame 212. The legs 286 are positioned such that there is a snap 284 located between each leg 286 and the mirror 214. As shown in FIG. 8, the legs 286 are generally rectangular in shape, but may include a variety of shapes or cross-sectional configurations, such as triangular, oval, or the like. Each leg also has a base 273 and an aperture or opening 272, located at a predetermined distance above the base. The aperture 272 is slightly undersized relative to the size of the upper portion 296 of the snap 284 so that the snap may be pressed through the aperture. Additionally, each leg 286 is provided with a hinge portion 274 (e.g., a living hinge, mechanical hinge, etc.) located between the aperture 272 and the base 273.

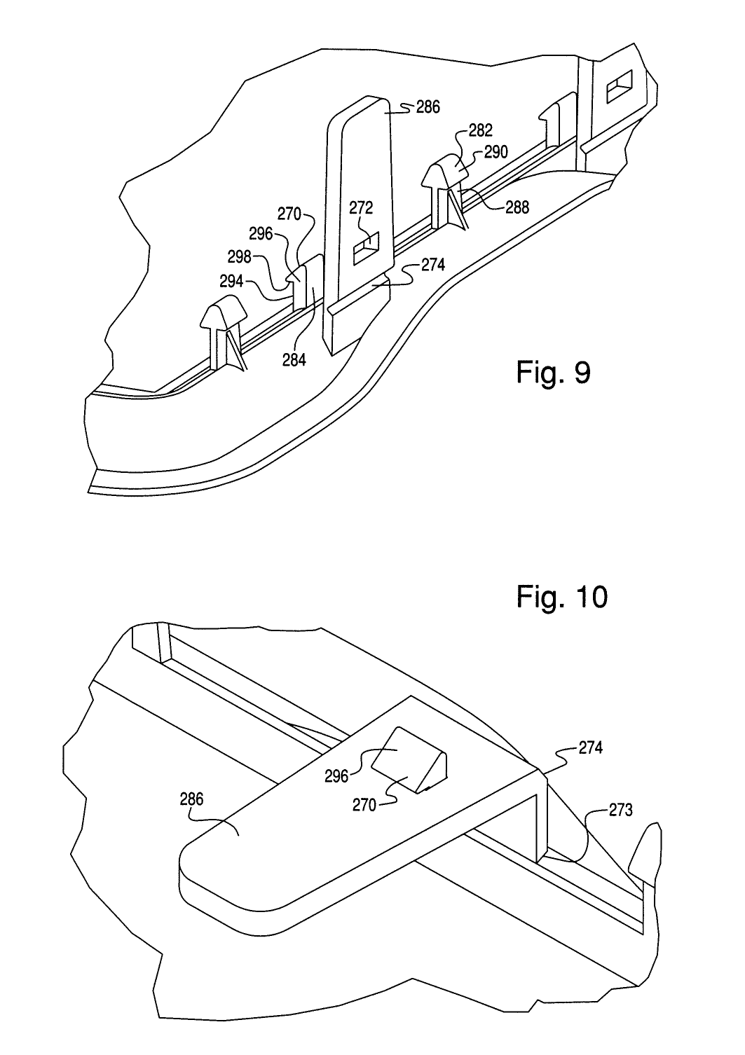

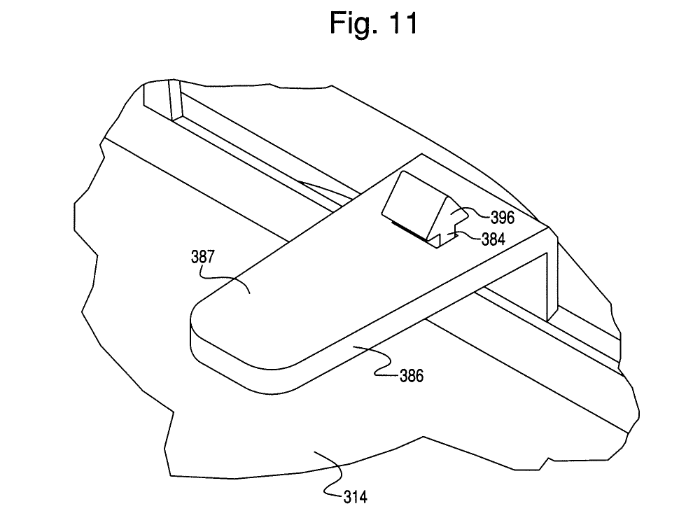

Referring to FIGS. 8 and 9, the positions of the legs 286 and the snaps 284, and the locations of the hinge portion 274 and the aperture 272 on the legs 286, are configured such that, after the placement of the mirror 214 into the vanity frame 212, each leg may be folded or bent at the hinge portion downward and inward toward the mirror 214 so that the upper portion 296 of the snap “snaps” through the aperture 272 of the leg. The shoulder 298 of the snap thereby secures the leg 286 in the bent position as seen in FIG. 10, and the leg 286 secures the mirror 214 in place. The legs 286 and snaps 284 may be further configured such that, in the folded position, the shoulder 298 of the snap exerts a bias force on the leg that is transferred to the rear surface of the mirror 214, further helping to secure the mirror in place and creating a preloaded condition.

It should be noted that the locations and sizes of the snaps and legs, and the locations and sizes of the aperture and hinge portion on each leg may be adjusted to accommodate mirrors of varying peripheral dimensions, widths, and thicknesses, and may be adjusted to apply varying amounts of preload force to the mirror via the legs.

In an alternative embodiment shown in FIG. 11, the snaps 384 may additionally serve as the connectors, having an upper portion 396 configured not only to secure the leg 386 in the folded position against the mirror 314, but also to secure the vanity to the remainder of the visor. The upper portion 396 of the snap 284 fits inside a mating aperture in the visor such that the surface of the visor abuts against the surface 387 of the leg 386.

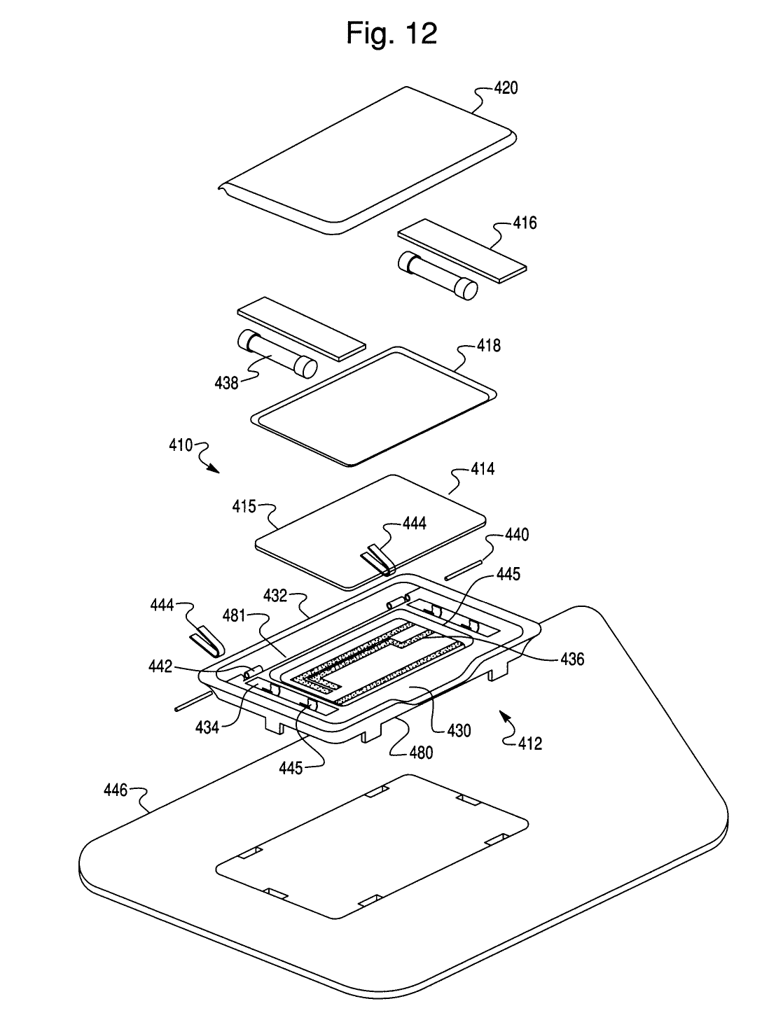

Referring back to FIGS. 8-10, the mirror 214 is loaded from the bottom of the vanity 210, thereby requiring that a substantial central opening or aperture in the frame 212 be provided so that the mirror 214 may be visible when only the top surface of the vanity 210 is exposed to the passenger. In an alternative embodiment, shown in FIG. 12, a vanity 410 is disclosed that may be loaded entirely from the top (i.e., the side that is visible upon assembly of the vanity into a visor). For example, a method for making a vanity for a visor may include the steps of providing a vanity frame having a first side with a top surface, and installing a light assembly, a mirror assembly, and a cover assembly from the first side of the vanity. According to one embodiment, the light assembly may comprise lights, lenses, and lighting circuitry; the mirror assembly may comprise a mirror and a mirror trim bezel; and the cover assembly may comprise a cover and hinges at its pivot points.

The vanity 410 of FIG. 12 includes a “bucket” type frame or housing 412 that has a support surface 430 upon which the mirror 414 and other components may be mounted from the top. The support surface is intended to support not only the mirror 414, but also other components, such as the lighting and lighting circuitry components. An advantage of this embodiment over many traditional vanity designs is the elimination of a separate backer, often made of plastic or cardboard, required to hold the lighting circuitry behind the mirror 414. In other words, the support surface 430 also acts as the mounting surface for the circuitry.

The support surface 430 of FIG. 12 extends beyond the periphery of the mirror 414, below the lighting components, and curves or extends upward such that the perimeter of the frame 412 may have a shoulder 432 where the vanity 410 and the visor core 446 interface. The portion of the support surface 430 behind the mirror 414 is substantially flat, but may contain voids or other passageways and mounting regions in which to place the lighting circuitry or other components. As shown in FIG. 12, the portion 434 of the support surface beneath the lighting may be contoured to accept one or more vanity light fixtures along with the associated circuitry.

A pair of vanity lights 438 are provided, and are mounted to either side of the mirror 414 in the contoured portions of the support surface 434. The vanity lights are powered by lighting circuitry 436 that may be in the form of a metal stamping that is insert molded into the support surface 430 beneath the mirror 414 and lights 438. Alternatively, the circuitry 436 may be adhesively, mechanically, or otherwise secured to the vanity frame 212 using any suitable means. In one embodiment, the lighting circuitry 436 may be, for example, an electrification stamping with a power source, such as a small battery. The metal stamping forming the lighting circuitry 436 may also serve as the mounting structure for the lights, being formed to conform to a cylindrical or other shaped lighting fixture and receive the vanity light 438 in a snap fit. A lens 416 covers each of the vanity lights 438. The lens 416 may be clear, or provided with a color, tint, smoke, or other translucent texture or surface coating. The lens 416 may be snapped in place from the top, or alternatively, may be mechanically fastened, adhesively secured, or held in by any other suitable means.

The mirror 414 is positioned on the mirror ledge portion of the support surface. The mirror 414 and support surface 430 may be provided with mating indents/detents (not shown) intended to locate the mirror 414 at the proper position upon the support surface prior to the installation of the mirror trim bezel 418. The mirror trim bezel 418 is located above the mirror 414, and generally conforms to the perimeter of the mirror 414. The bezel 418 is secured between the periphery of the mirror 414 and the vanity lighting, and may be configured such that once installed the bezel provides a bias force against the mirror so as to prevent the mirror from moving from its desired position. The bezel 418 is secured to the vanity frame 412. A lower portion of the bezel 418 may extend down beyond the edge 415 of the mirror 414 so as to be in contact with the support surface 430. The bezel 418 may be ultrasonically welded, mechanically secured, or fastened to the vanity frame 412 using any other suitable means.

Further referring to FIG. 12, the vanity 410 includes a cover 420. The cover 420 is rotatably attached to the vanity frame 412 along a pivot axis so as to allow the cover to be rotated from a closed position to an open position. The interface between the cover 420 and the frame 412 may be any suitable hinge or pin or other device that allows for the rotation of the cover relative to the vanity frame. According to one embodiment, hinge pins 440 may be used to fit inside apertures 442 formed in the frame 412 and along the pivot axis and the opening and closing of the cover 420 can be achieved using detent springs 444. The cover 420 and frame 412 may also be configured to interface with each other in accordance with one or more of the various other exemplary embodiments disclosed herein, and to provide for a positive on/off feature to control the vanity lighting. For example, an extension arm attached to the cover, a metal pin inserted in the extension arm, and an opening in the frame 412 so as to allow the metal pin to make contact with stamping legs in electrical contact with the lighting circuitry can be utilized, as described in reference to FIGS. 3-5.

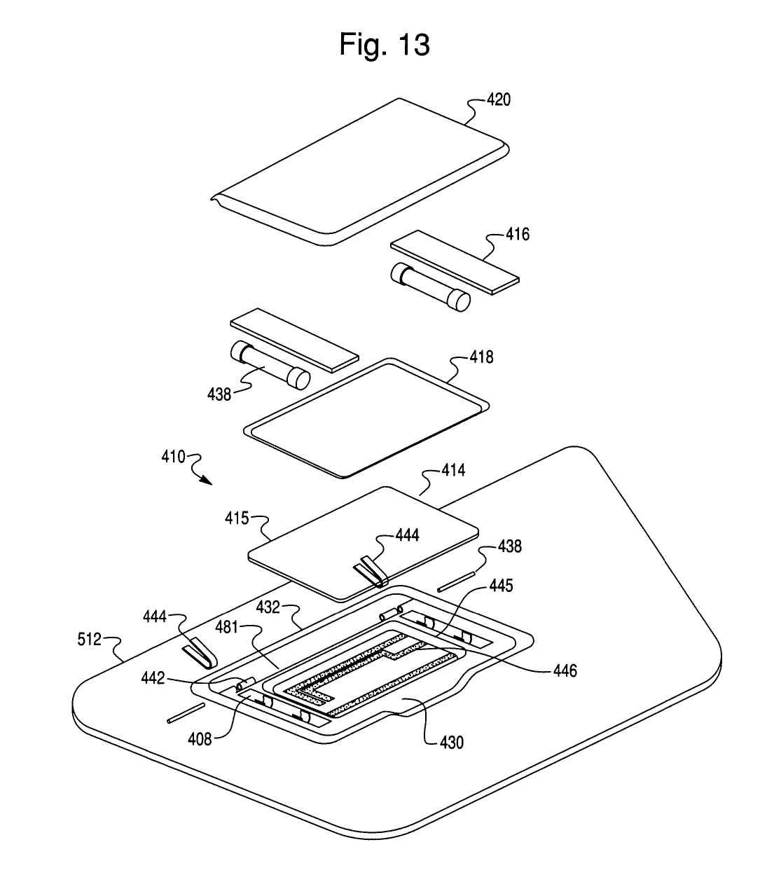

It should be noted that as shown in FIG. 12, the vanity housing or frame 412 is a separate component from the visor core, intended to be installed into the visor core 446 either prior to or after the installation of the vanity sub-components. For example, connectors similar to those shown in FIG. 8 may be attached or integrated in the back surface 480 of the vanity frame 412 so as to fit in mating connectors in the visor core 446. In an alternative embodiment, the vanity frame or housing 512 is formed as an integral part of the vanity core as shown in FIG. 13. That is, the visor core and the vanity housing are a single piece made via one or more manufacturing processes (e.g., injection or insert molding) thereby further reducing the number of steps and components involved in the assembly of the vanity and visor.

The various components of the vanity 410 disclosed in FIG. 12 and described herein as an exemplary embodiment of the invention may be utilized in the assembly of a vanity using a streamlined method of assembly intended to reduce the typical assembly time of vanities and minimize material costs. According to an exemplary embodiment, a vanity frame or housing 412 is provided. The vanity frame 412 has a support surface 430 configured to support the various subcomponents of the vanity 410 including, but not limited to, a mirror 414, one or more vanity lights 438, the vanity lighting circuitry 436, the vanity lens components 416, the mirror trim bezel 418, and the vanity cover 420. Other components may also be included as required (e.g., detent springs 444, miscellaneous fasteners, etc.). The vanity frame 412 has a top surface 481 and a bottom surface 480, the bottom surface 480 being in contact with the visor core 446 upon assembly of the complete visor. The top surface 481 includes a support surface 430 and provides the mounting structure for the remainder of the vanity components. According to the embodiment illustrated in FIG. 12, all of the vanity subcomponents are intended to be installed from the top surface 430 of the vanity.

The lighting circuitry 436 for the vanity 410 is secured to the support surface 430. In an exemplary embodiment, the circuitry 436 is a metal stamping that is insert molded into the vanity frame 412. The metal stamping may additionally provide the mounting structure for the vanity lights 438, such as clamps 445. The mirror 414 is then located on the support surface, covering at least a portion of the lighting circuitry 436. The vanity lights 438 and lens components 416 are then positioned in place. The lights and lens components may be snapped into place, being configured to have or interface with resilient components to provide for an easy and secure method of mounting.

Upon positioning of the mirror 414 and lighting components, the mirror trim bezel 418 is placed onto the vanity and properly positioned around the periphery of the mirror 414. In an exemplary embodiment, the trim bezel extends around the edges 415 of the mirror 414 to the support surface 430 and is then ultrasonically welded to the support surface. The vanity cover 420 is then rotatably coupled to the vanity frame 412. In an exemplary embodiment, the cover 420 may be snapped onto the frame 412 at one or more points that serve as rotation points between the cover 420 and the frame 412.

In an alternative embodiment of the method of assembly described herein, the vanity frame 512 is injection molded as an integral part of the visor core as seen in FIG. 13, further reducing the number of assembly steps and the number of parts involved. The visor core then serves to act as the vanity frame or housing, with the support surface being an integral part of the visor core. The remaining subcomponents are then installed into the vanity frame/visor core as described herein with respect to the separately formed vanity housing or frame 412.

According to any of these or other exemplary embodiments, other components may be attached to the vanity, such as accessories and mounting devices to suit other desired applications.

It should be noted that the elements and/or assemblies of the vanity may be constructed from any of a wide variety of materials that provide sufficient strength or durability, including any of a wide variety of moldable plastic materials (such as high-impact plastic), or foams, polymers, etc. and in any of a wide variety of colors, textures, and combinations. The shape and size of the various components may be varied to improve the appearance, formability, and assembly of the vanity and the vanity sub-components. Other substitutions, modifications, changes, and omissions may be made in the design, operating conditions, and arrangement of the preferred and other exemplary embodiments without departing from the scope of the present inventions.

It is important to note that the construction and arrangement of the elements of the vanity and the methods for making a vanity as shown in the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature of number of discrete elements or positions may be altered or varied. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performed the recited function and not only structural equivalents but also equivalent structures. Other substitutions, modifications, changes and omissions may be made in the design, operating conditions and arrangement of the exemplary embodiments without departing from the scope of the present inventions as expressed in the appended claims.

What is claimed is:

1. A vanity for a visor comprising:
a frame, wherein at least one metal stamping extends from the frame;
a cover attached to the frame at a pivot point, wherein an extension arm is connected to the cover; and
a metal pin extending from the extension arm,
wherein the extension arm is configured to rotate the metal pin into contact with the metal stamping when the cover is closed and to rotate the metal pin out of contact with the metal stamping when the cover is opened.

2. The vanity for a visor according to claim 1, wherein the at least one metal stamping comprises two metal stamping legs, wherein the metal stamping legs are part of a lighting circuit connected to at least one vanity light.

3. The vanity for a visor according to claim 2, wherein the lighting circuit turns on the at least one vanity light when the metal pin is in contact with the two metal stamping legs, and turns off the at least one vanity light when the metal pin is out of contact with the metal stamping legs.

4. The vanity for a visor according to claim 1, wherein the at least one metal stamping is configured to deflect when the metal pin is in contact with the at least one metal stamping.

5. The vanity for a visor according to claim 1, wherein the frame comprises an aperture configured such that the extension arm and the metal pin pass through the aperture when the cover is opened or closed.

6. The vanity for a visor according to claim 1, wherein the metal pin is inserted into an aperture located in the extension arm.

7. A vanity for a visor comprising:
a frame, wherein a pair of stamping legs extend from the frame; and
a cover attached to the frame at a pivot point,
a first actuation tab extending from the cover, wherein the first actuation tab is configured to prevent contact between the pair of stamping legs when the cover is closed and to permit contact between the pair of stamping legs when the cover is opened.

8. The vanity for a visor according to claim 7, further comprising a second actuation tab extending from the cover, wherein the second actuation tab is configured to cause contact between the pair of stamping legs when the cover is opened.

9. The vanity for a visor according to claim 8, wherein the frame comprises an aperture configured such that at least one of the first actuation tab and the second actuation tab passes through the aperture when the cover is opened or closed.

10. The vanity for a visor according to claim 7, wherein the pair of stamping legs are part of a lighting circuit connected to at least one vanity light.

11. The vanity for a visor according to claim 10, wherein the lighting circuit turns on the at least one vanity light when the stamping legs are in contact with each other, and turns off the at least one vanity light when the stamping legs are out of contact with each other.

12. The vanity for a visor according to claim 7, wherein at least one of the pair of stamping legs have a spring memory such that the pair of stamping legs are capable of a biased engagement.

13. The vanity for a visor according to claim 7, wherein the pair of stamping legs each have curved surfaces capable of allowing a bias force upon engagement of the stamping legs.

14. The vanity for a visor according to claim 7, wherein one of the pair of stamping legs comprises a C-shape at a distal end and an electrical contact with lighting circuitry at a proximal end.

15. The vanity for a visor according to claim 7, wherein one of the pair of stamping legs comprises a J-shape at a distal end and an electrical contact with lighting circuitry at a proximal end.

16. A vanity for a visor comprising:
a mirror;
a frame configured to receive the mirror from a bottom surface;
at least one upstanding leg attached to the bottom surface of the frame, wherein the at least one leg comprises a hinge portion and an aperture; and
a snap comprising a lower portion and an upper portion,
wherein the at least one upstanding leg is configured to be folded at the hinge portion so that the upper portion of the snap passes through the aperture in the leg so as to secure the leg in a folded position

17. The vanity of a visor according to claim 16, wherein a portion of the leg is in contact with the mirror when the leg is secured in the folded position.

18. The vanity of a visor according to claim 16, wherein the snap is configured to be a connector to be mated to a visor core.

19. The vanity of a visor according to claim 16, wherein the upper portion of the snap has a tapered surface so as to facilitate the passing of the upper portion through the aperture of the leg.

20. The vanity of a visor according to claim 16, wherein the leg and snap are configured such that the snap exerts a bias force on the leg for securing the mirror in place in a preloaded condition.

21. A vanity for a visor comprising:
a mirror;
a light assembly; and
a frame,
wherein the vanity has a top surface that is viewable by an occupant of a vehicle when in use and the vanity is configured such that the mirror and the light assembly are assembled to or disassembled from the frame from the top surface side.

22. The vanity for a visor according to claim 21, wherein the light assembly comprises at least one vanity light covered by a lens and lighting circuitry.

23. The vanity for a visor according to claim 21, further comprising a cover, wherein the vanity is configured such that the cover is assembled to or disassembled from the frame from the top surface side.

24. The vanity for a visor according to claim 21, further comprising a trim bezel configured to provide a bias force against the mirror, wherein the vanity is configured such that the trim bezel is assembled to or disassembled from the frame from the top surface side.

25. The vanity for a visor according to claim 21, wherein the frame is integral with a visor core.
